(19) United States
(12) Patent Application Publication
(10) Pub. No.: US 2007/0057228 A1
(43) Pub. Date: Mar. 15, 2007

(54) HIGH PERFORMANCE COMPOSITE ELECTRODE MATERIALS

(75) Inventors: Biying Huang, Ann Arbor, MI (US); Suresh Mani, Ann Arbor, MI (US); Jun Q. Chin, Waterford, MI (US)

Correspondence Address: GIFFORD, KRASS, GROH, SPRINKLE & CITKOWSKI, P.C, PO BOX 7021, TROY, MI, 48007-7021, US

(73) Assignee: T/J Technologies, Inc., Ann Arbor, MI (US)

(21) Appl. No.: 11/531,718

(22) Filed: Sep. 14, 2006

Related U.S. Application Data
(60) Provisional application No. 60/717,174, filed on Sep. 15, 2005.

(51) Int. Cl. H01M 4/58; H01M 4/50; H01M 4/52; H01M 4/48

(52) U.S. Cl. 252/182.1; 429/231.95; 429/223; 429/231.1; 429/231.3; 429/224; 429/231.6

(57) ABSTRACT

A composite electrode material is fabricated from a first electroactive material which, when incorporated into a cathode of a rechargeable battery, manifests a first mean voltage, a first energy density and a first high cutoff voltage cycle life; and a second electroactive material which, when incorporated into a cathode of the rechargeable battery, manifests a second mean voltage which is less than the first mean voltage, a second energy density which is less than the first energy density, and a second high voltage cutoff cycle life which is greater than the first cycle life. The composite material is characterized in that when it is incorporated into a cathode of the rechargeable battery, it manifests at least one of: a third mean voltage which is greater than the second mean voltage, a third energy density which is greater than the second energy density, and a third high cutoff voltage cycle life which is greater than the first cycle life. The rate performance of the second material, when incorporated into a rechargeable battery, may be greater than the rate performance of the first material when incorporated into the rechargeable battery, and the rate performance of the composite material, when incorporated into a cathode of the rechargeable battery, is greater than the first rate performance. The composite material may include a simple mixture of particles of the first and second materials, or may comprise a complex structure such as a core/shell structure wherein the second material covers a portion of the surface of particles of the first material. Also disclosed herein are electrodes which incorporate the material, batteries which incorporate the electrodes, and methods for making the foregoing.

### RELATED APPLICATION

This application claims priority of U.S. Provisional Patent Application Ser. No. 60/717,174 filed Sep. 15, 2005, entitled “High Performance Composite Electrode Materials.”

### FIELD OF THE INVENTION

This invention relates generally to materials. More specifically, the invention relates to electrochemically active materials which may be employed as an electrode of a rechargeable battery. Most specifically, the invention relates to composite, electrochemically active materials which can be used to produce anodes and cathodes for rechargeable batteries having high voltage, high power capacity, and very good cycle life.

### BACKGROUND OF THE INVENTION

The performance characteristics of rechargeable batteries are directly related to the electrochemical properties of the materials which comprise their anodes and cathodes. If such materials can be improved, the quality of batteries which incorporate them will be improved.

Rechargeable lithium batteries utilize a cathode which stores and releases lithium as the battery is charged and discharged. The performance characteristics of the cathode material affect the overall performance characteristics of batteries in which it is incorporated.

One class of cathode materials which is utilized in lithium batteries comprises oxide-based materials having the general formula Li₁₋ₓM_{y}M′_{1-y-z}M″_{z}O₂ wherein x, y and z are independently in the range of 0-1, and M, M′ and M″ are transition metals. In one particular group of materials, M and M′ are selected from the group consisting of Ni, Mn, Al, Mg, Ti, Cr, and Co. In one particular group of such materials, at least one of M and M′ is Co. And, LiCoO₂ is one specific example of such a material. Lithium batteries which incorporate such materials in their cathode have a high voltage and a high energy density, which is a measure of amount of power stored per unit of weight. However, batteries incorporating such cathodes have a poor cycle life when charged to high cutoff voltages, as for examples voltages in the range of 4.2 to 4.5 volts. That is to say, their performance characteristics degrade as the battery progresses through cycles of charge and discharge under high voltage cutoff conditions where upper voltages are at least 4.2 volts and in particular instances in the range of 4.2 to 4.5 volts. This degradation in cycle life appears to be related to a loss of integrity of the cathode material with charge/discharge cycling. This is believed to be due to a volume change in the material as a result of lattice expansion during charging. Wile this type of degradation can be lessened by cycling the batteries through lower voltage cutoff cycles, doing so decreases the net charge capacity. In addition to the foregoing, batteries based upon such oxide materials have some safety problems resultant from a thermal runaway during charging and/or discharging. Such thermal runaway can cause an explosion or fire in the battery material.

Another group of cathode materials utilized in lithium batteries comprise lithiated metal compounds of complex ions such as phosphate ions. One specific group of materials of this type is based upon lithiated iron phosphates. Cathode materials of this type may include further transition metals and/or may be based upon transition metals other than iron. Cathode materials of this type manifest good cycle life, and are not prone to thermal runaway. However, the overall voltage produced by this group of materials, as for example lithium iron phosphates, is lower than is the voltage produced by oxide materials. As a consequence, the energy density of batteries based upon these materials is also lower than is the energy density of batteries based upon oxide materials.

As will be explained in detail hereinbelow, the present invention provides a composite material which may be used to fabricate electrodes for battery systems. The materials of the present invention can be used to produce lithium batteries which combine high voltage, high capacity and high rate performance with good cycle stability.

### BRIEF DESCRIPTION OF THE INVENTION

Disclosed herein is a composite electrode material. The material includes a first electroactive material which, when incorporated into a cathode of a rechargeable battery, manifests a first mean voltage, a first energy density, and a first cycle life under high voltage cutoff conditions of at least 4.2 volts. The composite electrode material further includes a second electroactive material which, when incorporated into a cathode of the aforementioned rechargeable battery, manifests a second mean voltage which is less than the first mean voltage, a second energy density which is less than the first energy density, and a second cycle life which is greater than the first cycle life when operated under high cutoff cycling, wherein the upper limit of the cycle is at least 4.2 volts. The composite material is further characterized in that when it is incorporated in a cathode of the rechargeable battery, it manifests at least one of: a third mean voltage which is greater than the second mean voltage; a third energy density which is greater than the second energy density; and a third cycle life under said 4.2 volt high voltage cutoff conditions which third cycle life is greater than the first cycle life.

In accord with a further aspect of the invention, the second electroactive material, when incorporated into the rechargeable battery, manifests a second rate performance which is greater than the rate performance of the first material when incorporated in said rechargeable battery, and wherein the composite material, when incorporated in a cathode of the rechargeable battery, manifests a third rate performance which is greater than the first rate performance. In the context of this disclosure, rate performance is measured by the percent capacity of the battery when charged and discharged at a relatively high rate such as a rate of 5 C or 10 C.

In specific instances, the first electroactive material comprises, on a weight basis, 5-95% of the material and the second electroactive material comprises, on a weight basis, 95-5% of the material. In other instances, the first material comprises, on a weight basis, 10-90% of the material and the second electroactive material comprises, on a weight basis, 90-10% of the composite material. In yet other instances, the first electroactive material comprises, on a weight basis, 80-20% of the material and the second electroactive material comprises, on a weight basis, 20-80% of the composite material. In a specific instance, the first electroactive material comprises, on a weight basis, approximately 70% of the material and the second electroactive material comprises, on a weight basis, approximately 30% of the composite material.

In one particular group of embodiments, the first electroactive material is an oxide of at least one metal and the second electroactive material is a phosphate of at least one metal. In a particular instance, the first electroactive material is of the general formula Li₁₋ₓM_{y}M′_{1-y-z}M″_{z}O₂ wherein x, y and z are independently in the range of 0-1, and M, M′ and M″ are independently selected from the group consisting of Ni, Al, Mg, Ti, Mn, Cr, and Co. In other embodiments, the second electroactive material is comprised of lithium, iron, and a phosphate group, and may further include an additional transition metal

In some instances, at least one of the first and second electroactive materials is present in the form of nanoparticles. In some specific instances, the first electroactive material is present in the form of particles, and the second electroactive material is present as a coating on at least a portion of the surface of at least some of said particles. In some particular instances, the first electroactive material comprises a core member, and the second electroactive material is a coating disposed upon the cores.

Also within the scope of the invention are methods for the preparation of the composite material.

### BRIEF DESCRIPTION OF THE DRAWINGS

FIG. 1 is a graph showing voltage versus specific capacity for a material of the present invention as incorporated into a rechargeable lithium battery;

FIG. 2 is a graph showing voltage versus energy density for a rechargeable battery including a cathode of the prior art and a rechargeable battery incorporating the composite material of the present invention;

FIG. 3 is a graph showing capacity versus cycle number for a rechargeable battery incorporating the composite material of the present invention;

FIG. 4 is a graph showing capacity versus cycle number for a rechargeable battery incorporating a metal oxide cathode of the prior art; and

FIG. 5 is a graph showing capacity versus cycle number for a battery incorporating the composite material of the present invention where cycling is carried out at various charge rates.

### DETAILED DESCRIPTION OF THE INVENTION

The present invention is directed to a composite material which may be utilized in a number of electrochemical applications. For example, the material may be used in electrodes of rechargeable lithium batteries. The material of the present invention is comprised of a mixture of electrochemically active materials which interact synergistically to provide a composite electrode material which may be used to produce batteries which are stable in use, safe, and which have a high voltage, high energy capacity, good rate performance and very good cycle life under high voltage cutoff conditions of at least 4.2 volts.

The composite material of the present invention is based upon a synergistic composition of electrochemically active materials. As is to be understood within the context of this disclosure, an electrochemically active material is a material which, when incorporated into a battery, intercalates and deintercalates ions (for example, lithium ions in the case of a lithium battery) during the use cycling of the battery. While the strategy and materials of the present invention are described primarily with reference to materials used as cathodes of lithium batteries, the principles of the invention may also be extended to cathodes and anodes of various rechargeable batteries. Such anodes, when incorporated into lithium batteries, will operate at a lower voltage and higher rate, as compared to conventional anode materials such as MCMB, and they will provide a higher energy density and power.

In the present invention, as applied to cathode materials, the composite material includes a first electrochemically active material characterized in that when it is incorporated into a cathode of a rechargeable battery, the battery manifests a first mean voltage, a first energy density, a first cycle life under high voltage cutoff conditions of at least 4.2 volts and a first high rate performance. The composite material of the present invention includes a second electroactive material which, when incorporated into a cathode of that same rechargeable battery, manifests a second mean voltage, which is less than the mean voltage of the first material, a second energy density which is less than the first energy density, a second cycle life under the aforementioned at least 4.2 volt cutoff conditions which is greater than the first cycle life and a better high rate performance than the first. The composite material is further characterized in that when it is incorporated into a cathode of that rechargeable battery, the battery manifests at least one of: a third mean voltage which is greater than the second mean voltage, a third energy density which is greater than the second energy density, and/or a third cycle life under high voltage cutoff conditions (at least 4.2 volts) which is greater than the first cycle life. This composite material also has a better high rate performance than does the first electrochemically active material.

A similar strategy of blending materials can be used to prepare anode materials having a lower operating voltage, a higher rate performance and a higher capacity. In some instances, the composite material may include more than two electroactive materials. It is the synergistic interaction of these electroactive materials which produces a battery which has a high voltage, high energy density, a good rate performance, and a very good cycle stability.

The proportions of the various electroactive materials may vary over a wide range. In some instances, tie first material comprises 5-99% by weight of the composite, and the second comprises 95-1% weight of the composite. In more specific embodiments, the ratios are 10-90%/90-10%, 80-20%/20-80%, and in one particular group of embodiments, the first electroactive material comprises 90% by weight of the composite and the second 10% by weight of the composite. In one particular group of embodiments, the first electroactive material is an oxide of a metal, and this material can have the general formula Li₁₋ₓM_{y}M′_{1-y-z}M″_{z}O₂ wherein x, y and z are independently in the range of 0-1, and M, M′ and M″ are transition metals. Some specific transition metals utilized in this embodiment include Ni, Al, Mg, Ti, Mn, Cr, and Co. In a particular group of such embodiments, at least one of the two metals is Co, and in a specific instance the material includes Ni and Co.

In certain embodiments, the second electroactive material includes lithium, iron and a phosphate, silicate, or similar group. This material may also, in particular instances, include another transition metal.

In the composite material of the present invention, the particles of the material interact in a synergistic manner so as to produce a material having electrochemical properties which are superior to those exhibited by the component materials taken singly. In some instances, the particles will interact to buffer volume changes resultant from cycling of battery electrodes during high cutoff charge and discharge cycles. As discussed above, such volume changes under high charging voltage conditions can lead to degradation of a material which decreases its performance. In the present invention, the lattice parameters of the materials differ; and therefore, mechanical strains produced by charging and discharging are minimized. Furthermore, it has been found that the introduction of the second phase decreases the possibility of particle agglomeration. The volume expansion associated with large agglomerates of particles of a single lithium metal oxide type material would be less reversible and hence more detrimental to electrode performance than would small voids resultant from the nanoscale composite of the present invention.

The particles of material comprising the composite material of the present invention may be of the same size or they may be of different sizes. In particular instances, at least the particles of the second material are nanoscale size particles. As is to be understood, nanoscale particles are defined to be particles having a submicron size. In particular instances, nanoscale particles are understood to have dimensions on the order of tens to hundreds of nanometers.

The present invention may be practiced utilizing different morphologies of particles; and in that regard, it is to be understood that the term “particles” is to be interpreted broadly. For example, in some instances the composite material may comprise a simple mixture of particles of the first and second material, optionally with binders, as well as with particles of additional electroactive or non-electroactive materials. In other instances, the particles of the first and second material may be configured into a more complex relationship. For example, the two materials may be disposed in a layered relationship or in a core/shell relationship wherein one of the materials is coated onto particles of the other. All of such geometries are understood to be within the definition of particles. Certain further benefits may come from utilizing such complex structures. For example, a second material having a high charge rate ability may be coated onto a first material having high energy density. The resultant composite material will retain the excellent rate ability of the second material and the high energy density of the first. Such composite structures may be prepared by a variety of techniques known to those of skill in the art. For example, core bodies of the first material may be coated with a second material by vapor deposition techniques, plasma deposition techniques or the like. In other instances, the particles of the first material may be coated with a second material by disposing precursor reagents of the second material onto the first and then reacting them so as to deposit a coating of the second material. Such reactions can include wet chemical reactions as well as vapor phase reactions and solid state reactions. In other instances, coatings of a second material may be disposed on a first material by strictly mechanical processes such as high impact milling techniques, ultrasonic techniques or the like.

The material of the present invention may, in particular instances, be prepared by simply mixing together particles of the first and second materials. This mixture may be in the form of a slurry, and may further include other components of a cathode such as a polymeric binder, carbon and the like. In some instances, the mixture may be ball milled or otherwise ground.

Some particular examples of composite materials of the present invention include the following: LiCo_{0.2}Ni_{0.8}O₂/LiFePO₄ (90/10 by weight); LiCo_{0.15}Ni_{0.85}Al_{0.05}O₂/LiFePO₄ (90/10 by weight); LiCo_{1/3}Ni_{1/3}O₂/LiFePo₄; LiCo_{0.8}AlₓTi_{y}O₂/LiFePO₄ (x, y independently in the range of 0-1); LiNi_{1/2}Mn_{1/2}O₂/LiFePO₄; and LiCoO₂/LiFePO₄. Yet other combinations and variations will be apparent to those of skill in the art. For example, the second component may include metals in addition to Fe and Li.

### EXPERIMENTAL

A material of the present invention was prepared and incorporated into cathodes of lithium battery test cells. The material was prepared by mixing together a polyvinylidene difluoride (PVDF) binder with a solvent comprising n-methylpyrrolidone (NMP), carbon (acetylene black) and LiFePO₄ so as to make a slurry. Thereafter, LiNiCoO₂ was added while the slurry was stirred at high speed so as to produce a homogeneous mixture. The resulting slurry was coated onto aluminum foil substrates. The NMP solvent was evaporated, and the resulting electrode composition comprised, on a weight basis: 90% of the active material, which in turn comprised, by weight 90% of the LiNiCoO₂, and 10% of the LiFePO₄; 5% carbon; and 5% PVDF. This electrode was incorporated into a lithium cell which included a lithium anode, and an electrolyte comprising a 1 M solution of LiPF₆ in a mixture of 1:1 by weight of ethylene carbonate (EC) and diethylene carbonate (DEC).

The resulting cells were tested in accord with conventional procedures by running them through charge and discharge cycles. Cycling tests were carried out at a current rate of C/5 for the formation cycle, and of C/2 for the life cycle, between 2.5 and 4.3 V, 4.4 V and 4.5 V, respectively. All voltages noted herein are with regard to a lithium metal anode.

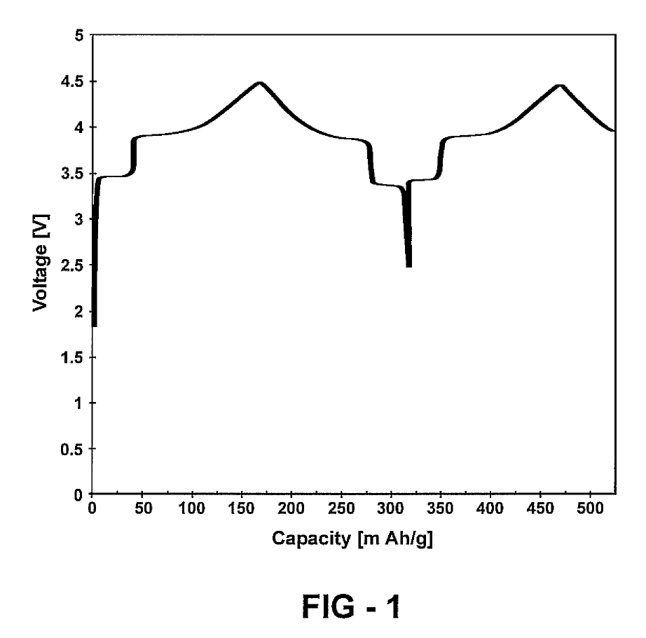

FIG. 1 is a graph of voltage versus capacity for two separate charge/discharge cycles for a cathode incorporating the material of the present invention. It will be noted that the second cycle is displaced relative to the first. This is for purposes of illustration. As will be seen, the capacity of this cell is over 160 mAh/g with a mean, working voltage of 3.75 V. It will also be noted that a second discharge voltage plateau is found at around 3.3 V and is attributable to the phosphate phase. Charging in this experimental series was at a C/2 rate.

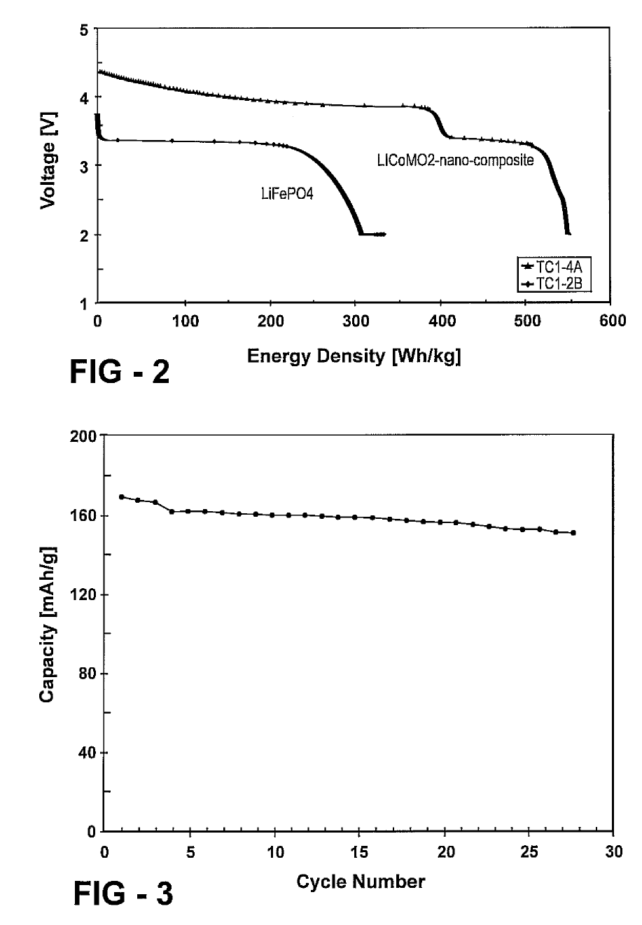

FIG. 2 shows a comparison of the energy density of a cell utilizing the composite material of the present invention as compared to the energy density of a comparable cell utilizing a lithium iron phosphate cathode of the prior art. As will be seen, the energy density of the material of the present invention is significantly higher than that of the prior art material.

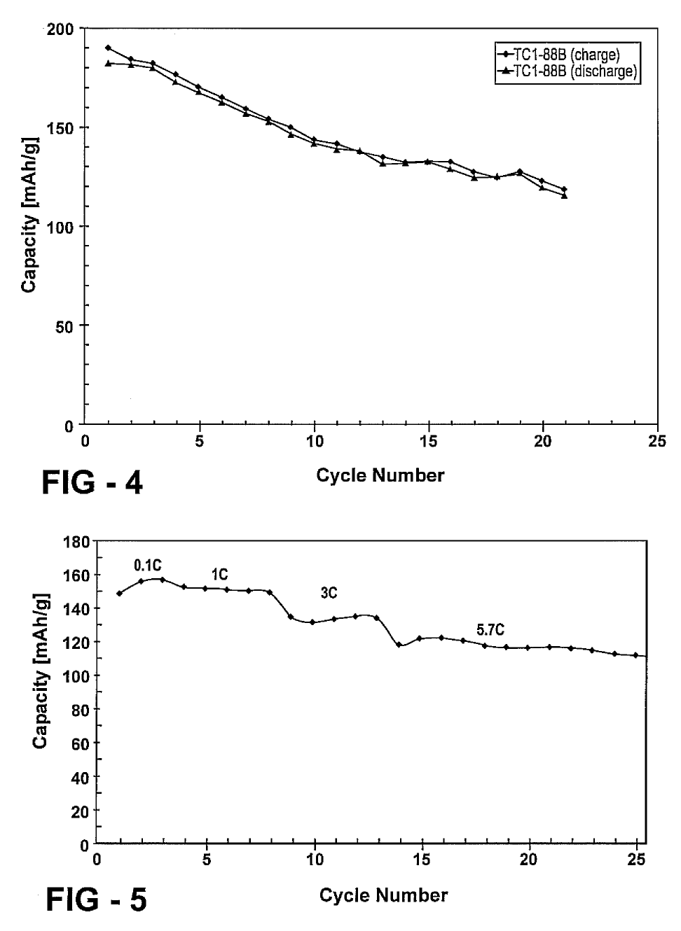

FIG. 3 shows the capacity in mAh/g of a cell incorporating a cathode of the present invention, as a function of charge/discharge cycle numbers. It will be seen that this cell maintains a high capacity over a large number of cycles, and in that regard manifests a performance which compares to the very best lithium iron phosphate materials. The cycle of prior art lithium cobalt oxide cathodes is shown, for comparison, in FIG. 4. FIG. 5 shows capacity versus cycle number for cells incorporating cathodes of the present invention wherein charge/discharge rates were varied from 0.1 C to 5.7 C. As will be seen, materials of the present invention produce cells which maintain superior capacity even under very high voltage conditions.

In summary, the foregoing makes clear that the present invention provides for composite, electrochemical materials in which the components interact synergistically to produce a material having superior properties. As such, the material of the present invention can be utilized to fabricate lithium batteries having a beneficial combination of good voltage, good capacity, high rate capabilities and good cycle life.

While the foregoing has been described with reference to cathodes for lithium batteries, the principles of this invention may be similarly extended to the preparation of both anodes and cathodes for a variety of battery systems not limited to lithium batteries. Likewise, the principles of the present invention may be used to manufacture electrodes for other electrochemical devices including storage devices such as ultracapacitors, as well as electrolysis cells, sensors, catalysts and the like.

In view of the disclosure and teaching presented herein, other formulations of composite material will be readily apparent to those of skill in the art as will be modifications and variations thereof. The disclosures discussion and examples presented herein are illustrative of specific embodiments of the invention, but are not meant to be a limitation upon the practice thereof. It is the following claims, including all equivalents, which define the scope of the invention.

1. A composite electrode material, said material comprising:
a first electroactive material which, when incorporated into a cathode of a rechargeable battery, manifests a first mean voltage, a first energy density, and a first cycle life under high voltage cutoff conditions of at least 4.2 volts;
a second electroactive material which, when incorporated in a cathode of said rechargeable battery, manifests a second mean voltage which is less than said first mean voltage, a second energy density which is less than said first energy density, and a second cycle life under high voltage cutoff conditions of at least 4.2 volts which second cycle life is greater than said first cycle life;
said composite material being further characterized in that when it is incorporated in a cathode of said rechargeable battery, it manifests at least one of: a third mean voltage which is greater than said second mean voltage, a third energy density which is greater than said second energy density, and a third cycle life under high voltage cutoff conditions of at least 4.2 volts, which third cycle life is greater than said first cycle life.

2. The electrode material of claim 1, wherein said second electroactive material, when incorporated into said rechargeable battery, manifests a second rate performance which is greater than a first rate performance of the first material when incorporated into said rechargeable battery; and wherein said composite material, when incorporated in a cathode of said rechargeable battery, manifests a third rate performance which is greater than said first rate performance.

3. The material of claim 1, wherein said first electroactive material comprises, on a weight basis, 5-99% of said material and said second electroactive material comprises, on a weight basis, 95-1% of said material.

4. The material of claim 1, wherein said first electroactive material comprises, on a weight basis, 80-20% of said material and said second electroactive material comprises, on a weight basis, 20-80% of said material.

5. The material of claim 1, wherein said first electroactive material is an oxide of at least one metal.

6. The material of claim 1, wherein said second electroactive material is a phosphate of at least one metal.

7. The material of claim 1, wherein the c lattice parameters of said first and second electroactive materials are different.

8. The material of claim 1, wherein said first electroactive material includes lithium, oxygen, and at least one metal selected from the group consisting of: Co, Ni, Al, Mg, Mn, Cr, and Ti.

9. The material of claim 1, wherein said first electroactive material is of the general formula: Li₁₋ₓM_{y}M′_{1-y-z}M″_{z}O₂ wherein x, y and z are independently in the range of 0-1, and M, M′ and M″ are independently selected from the group consisting of: Ni, Al, Mg, Ti, Mn, Cr, and Co.

10. The material of claim 9, wherein at least one of M, M′ and M″ is Co.

11. The material of claim 1, wherein said second electroactive material includes lithium, iron and a phosphate group.

12. The material of claim 11, wherein said second electroactive material further includes a transition metal in addition to said iron.

13. A cathode for an electrochemical battery which includes the material of claim 1.

14. A lithium battery which includes the cathode of claim 13.

15. The material of claim 1, wherein at least one of said first electroactive material and said second electroactive material is in the form of nanoscale particles.

16. The material of claim 1, said first electroactive material comprises a plurality of particles, and wherein at least a portion of said second electroactive material is disposed as a coating on at least a portion of the surfaces of at least some of said particles.

17. A method for making an electrode material, said method comprising the steps of:
providing a first electroactive material which is characterized in that when it is incorporated in a cathode of a rechargeable battery, it manifests a first voltage, a first energy density, a first cycle life under high voltage cutoff conditions of at least 4.2 volts, and a first high rate performance;
providing a second electroactive material which is characterized in that when it is incorporated in a cathode of said rechargeable battery, it manifests a second voltage which is less than said first voltage, a second energy density which is less than said first energy density, a second cycle life under high voltage cutoff conditions of at least 4.2 volts which second cycle life is greater than said first cycle life, and a second high rate performance which is greater than the first high rate performance; and
mixing together said first and second electroactive materials so as to provide a composite material which is characterized in that when it is incorporated into a cathode of said rechargeable battery, it manifests a third voltage which is greater than said second voltage, a third energy density which is greater than said second energy density, a third cycle life under high voltage cutoff conditions of at least 4.2 volts which third cycle life is greater than said first cycle life, and a third high rate performance which is greater than the first high rate performance.

18. A composite electrode material, said material comprising:
a first electroactive material which, when incorporated into an anode of a rechargeable battery, manifests a first voltage, a first energy density, a first cycle life under high voltage cutoff conditions of at least 4.2 volts, and a first high rate performance;
a second electroactive material which, when incorporated into an anode of said rechargeable battery, manifests a second voltage which is greater than said first voltage, a second energy density which is less than said first energy density, a second cycle life under high voltage cutoff conditions of at least 4.2 volts which second cycle life is greater than said first cycle life, and a second high rate performance which is greater than said first high rate performance; said composite material being further characterized in that when it is incorporated in an anode of said rechargeable battery it manifests a third voltage which is less than said second voltage, a third energy density which is greater than said second energy density, a third cycle life under high voltage cutoff conditions of at least 4.2 volts which third cycle life is greater than said first cycle life, and a third high rate performance which is greater than said first high rate performance.

19. The material of claim 18, further characterized in that when it is incorporated in said anode of said rechargeable battery, it manifests a third capacity which is greater than a second capacity manifested by said second material when it is incorporated in an anode of said rechargeable battery.
